(19) United States
(12) Patent Application Publication
(10) Pub. No.: US 2005/0116127 A1
(43) Pub. Date: Jun. 2, 2005

(54) Multi-axis adjusting apparatus

(75) Inventor: Kuo-Wen Chen, Chu-Nan (TW)

Correspondence Address: BACON & THOMAS, PLLC, 625 SLATERS LANE, FOURTH FLOOR, ALEXANDRIA, VA, 22314, US

(73) Assignee: Coretronic Corporation, Chu-Nan (TW)

(21) Appl. No.: 10/989,297

(22) Filed: Nov. 17, 2004

(30) Foreign Application Priority Data
Nov. 28, 2003 (TW) 092133719

(51) Int. Cl. F16M 11/02

(52) U.S. Cl. 248/179.1

(57) ABSTRACT

A multi-axis adjusting apparatus comprises a base seat and a first rotating seat, second rotating seat and elevating seat mounted on the base seat in a sequence. One end of the first rotating seat is pivotally connected to the base seat, and propping seats and first adjusting elements are disposed on the flank side of another end thereof. One end of the second rotating seat is pivotally connected to the first rotating seat, and a second adjusting element is installed below another end thereof. The elevating seat has a fixing seat and movable seat, in which an adjusting shaft passing through an eccentric wheel is pivotally connected to the fixing seat and the top face of the eccentric wheel is propped against the movable seat to allow the elevation movement of the movable seat to be controlled by changing the axial pitch of the eccentric wheel.

### BACKGROUND OF THE INVENTION

1. Field of the Invention

The present invention relates to a multi-axis adjusting apparatus, and more particularly to a multi-axis adjusting apparatus for a rear projection display device.

2. Description of Related Art

Please refer to FIG. 1. An image beam is provided by a conventional rear projection display device and projected to a reflecting mirror 4 through an optical engine assembly 3 in a housing 2, and then projected onto and displayed at a screen 5 after being reflected by the reflecting mirror 4. But, the production tolerances and the assembly tolerances exist in the optical engine assembly 3, the reflecting mirror 4 and the screen 5 cause the image beam not able to be aligned with the screen 5 so that the deformation of image is generated.

The conventional solution is shown in FIG. 2. An adjusting apparatus 10 is installed below the optical engine assembly. The adjusting apparatus 10 comprises a base seat 11, a X-axis sliding seat 12, a Y-axis sliding seat 13 and a rotating seat 14 stacked in a sequence on the base seat 11, in which the optical engine assembly 3 is fixed on the rotating seat 14 and the lens thereof is disposed parallel to the Y-AXIS. The X-axis sliding seat 12 is driven by rotating a first adjusting element 121 to move along the X-axis so as to attain to the rightward or leftward movement relative to the screen 5 of the image adjustment, as an image 5A shown in FIG. 3 shows. And, the Y-axis sliding seat 13 is driven by revolving a second adjusting element 131 to move along the Y-axis so as to attain to the amplification ratio of the image adjustment. Further, the rotating seat 14 is pushed by revolving a third adjustment element 141 to rotate around the Y-axis so as to revise the deformed image caused by the rotating angle of the plane of the screen 5, as a image 5C shown in FIG. 3 shows. However, the conventional adjusting apparatus 10 allows the image to do rightward and leftward, amplification and contraction, and deformed adjustments on the picture of the screen 5 only can attain to the alignment of the image to the screen. As to the unequal length of the optical path of the projected image to cause an image deformation (e.g. upward and downward trapezoid or leftward and rightward deformation) when a leftward and right or frontward and rearward slanting generated in the optical engine assembly 3, the adjusting apparatus mentioned above cannot be used to provide the deformation adjusting function. Therefore, the problem concerning the adjustment of the image deformation is still expected to be improved.

### SUMMARY OF THE INVENTION

One object of the present invention is to provide a multi-axis adjusting apparatus, enabling leftward and rightward, frontward and rearward adjustments to be done on an optical engine assembly so as to attain to the adjustment of an image deformation by installing first and second rotating seats.

For attaining to the object mentioned above, a multi-axis adjusting apparatus according to the present invention comprises a base seat and a first rotating seat, a second rotating seat and an elevating seat mounted in a sequence on the base seat. One end of the first rotating seat is pivotally connected to the base seat, and propping faces and first adjusting elements are disposed on the flank side of another end thereof. One end of the second rotating seat is pivotally connected to the first rotating seat, and second adjusting elements are installed below another end thereof. The elevating seat has a fixing seat and movable seat, in which an adjusting rod passed through with an eccentric wheel is pivotally connected on the fixing seat and the top face of the eccentric wheel is propped against the movable seat so as to allow the elevation movement of the movable seat to be controlled by changing the axial pitch of the eccentric wheel. After the optical engine assembly is mounted on the elevating seat, the first and second rotating seats can be rotated around a pivoting axis by revolving the first and the second rotating elements so as to adjust the leftward, the rightward, the frontward or the rearward inclined angles of the optical engine assembly to attain to the revision of the image deformation.

### BRIEF DESCRIPTION OF THE DRAWINGS

FIG. 1 is a schematic view, showing an optical system of a rear projection display apparatus of the prior art.

FIG. 2 is a perspective view, showing a structure of a multi-axis adjusting apparatus of the prior art.

FIG. 3 is a schematic view, showing a state of an image displayed on a screen of a rear projection display apparatus of the prior art.

FIG. 4 is a perspective view, showing a multi-axis adjusting apparatus according to the present invention.

FIG. 5 is an explosive view, showing a multi-axis adjusting apparatus according to the present invention.

FIG. 6 is a schematic view, showing the action of a first rotating seat according to the present invention.

FIGS. 7A and 7B are schematic views, showing a state of an elastic plate after adjusting when a first rotating seat is adjusted according to the present invention.

FIG. 8 is a schematic view, showing an action of a second rotating seat according to the present invention.

FIGS. 9A and 9B are schematic views, showing an action of an elevating seat according to the present invention.

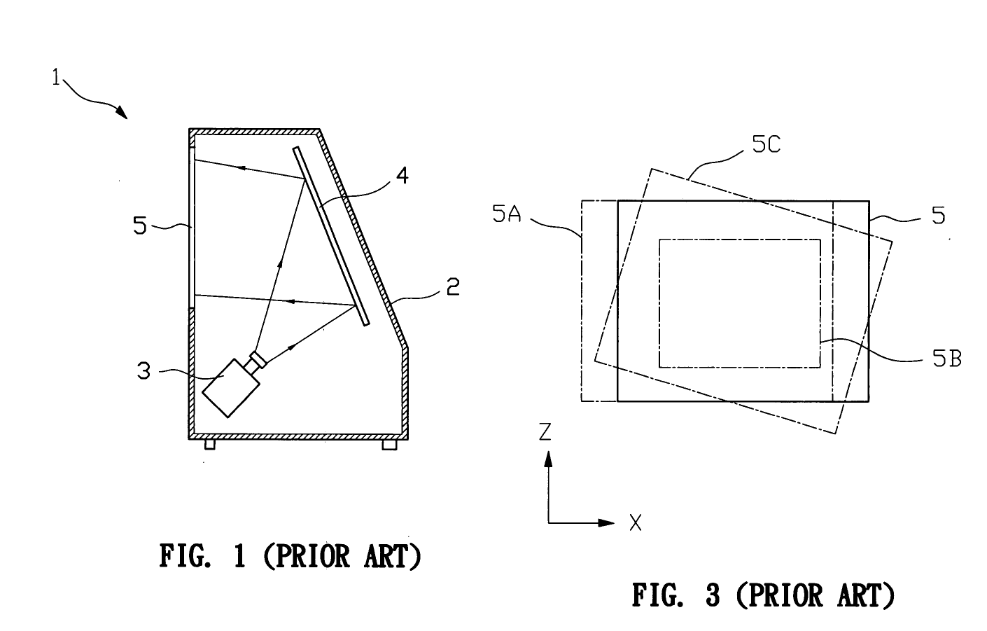

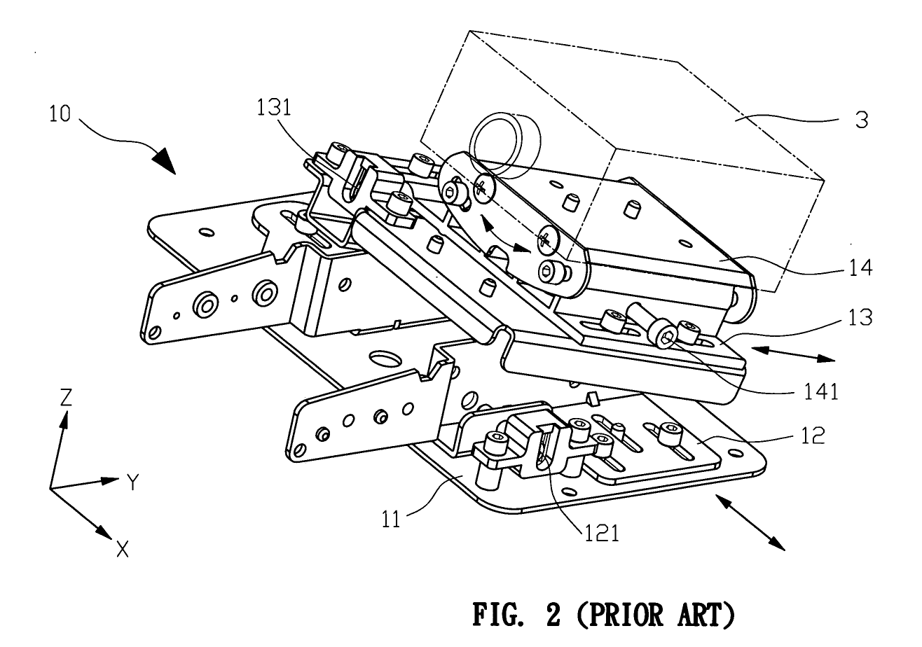

### DETAILED DESCRIPTION OF THE PREFERRED EMBODIMENTS

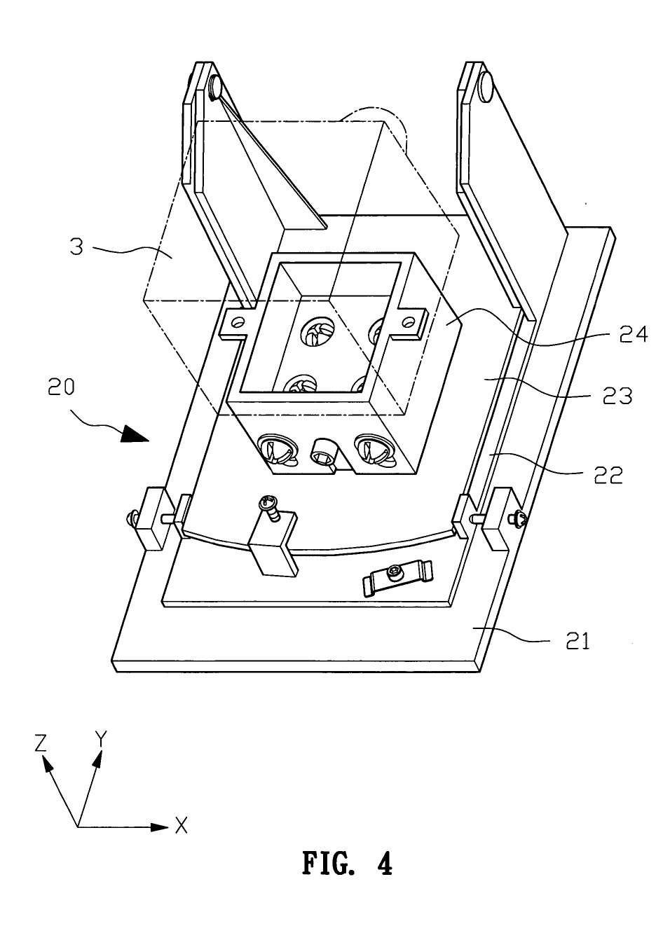

Please refer to FIG. 4. A multi-axis adjusting apparatus 20 comprises a base seat 21 and a first rotating seat 22, a second rotating seat 23 and an elevating seat 24 mounted in a sequence on the base seat 21, in which an optical engine assembly 3 is mounted on the elevating seat 24. The optical engine assembly 3 can be a single optical engine or an optical engine with an adjusting apparatus of the conventional technology mentioned above.

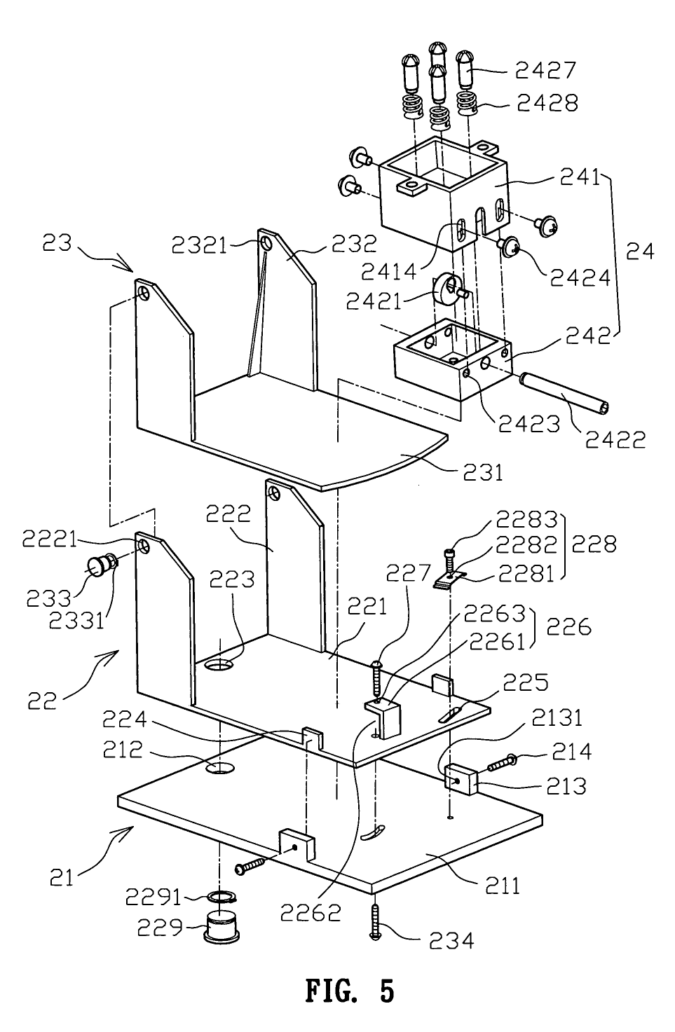

Please refer to FIG. 5. The base seat 21 is a rectangular base plate 211; a through hole 212 is disposed in one end of the rectangular base plate 211 and a fixing plate 213 is perpendicularly upward disposed on each of the two sides of another side thereof. A screw hole 2131 is disposed in the fixing plate 213 and an adjusting element is passed through the screw hole 2131.

The first rotating seat 22 is mounted on the rectangular base plate 211 of the base seat 21; the rotating seat 22 has a rectangular fist base plate 221 and a first side plates 222 respectively disposed on the two sides of one end thereof. A through hole 2221 with a central axis parallel to a Y-axis is disposed in the upper end of the first side plate 222. A pivoting hole 223 with a central axis parallel to a Z-axis located between the two first side plate 222 is disposed in the first base plate 221, and a propping face 224 is disposed at each of the two sides of another end of the first base plate 221 relative to the fixing plate 213 of the base seat 21. An arc guide groove 225 is disposed at the neighborhood of one of the propping faces 224, a “ [symbol] ” shape elastic plate 228 is installed on the arc guide groove 225, and a through hole 2282 is disposed in a top face 2281 of the elastic plate 228 for a guide element 2283 to pass through the through hole 2282 and then pass through the arc guide groove 225, one end thereof is finally screwed in the rectangular base plate 211 of the base seat 21 so as to guide the first rotating seat 22 to rotate around the pivoting hole 223 relatively to the base seat 21. The installment of the “ [symbol] ” shape elastic plate 228 is used to control conveniently the clamping force on the first base plate 221 by means of the Z direction deformation amount of the elastic plate 228. A reverse L shape plate 226 is fixed on the first base plate 221 between the two sides of the propping faces 224 and a gap 2262 is allowed to exist between a top face 2261 of the plate 226 and the first base plate 221. A screw hole 2263 is disposed in the top face 2261 of the reverse L shape plate 226 and a fixing element 227 is passed through it. A pivoting rod 229 is passed upward through the through hole 212 and the pivoting hole 223 from below the base seat 21, and an elastic clamping washer 2291 is then used to limit the free end of the pivoting rod 229 to get the first rotating seat 22 to be pivotally connected to the base seat 21. And, one end of the first adjusting element 214 is propped against the propping face 224 after being passed through the screw hole 2131 from outside so as to push the first rotating seat 22 to rotate around the central axis (i.e. Z-axis) of the pivoting hole 223.

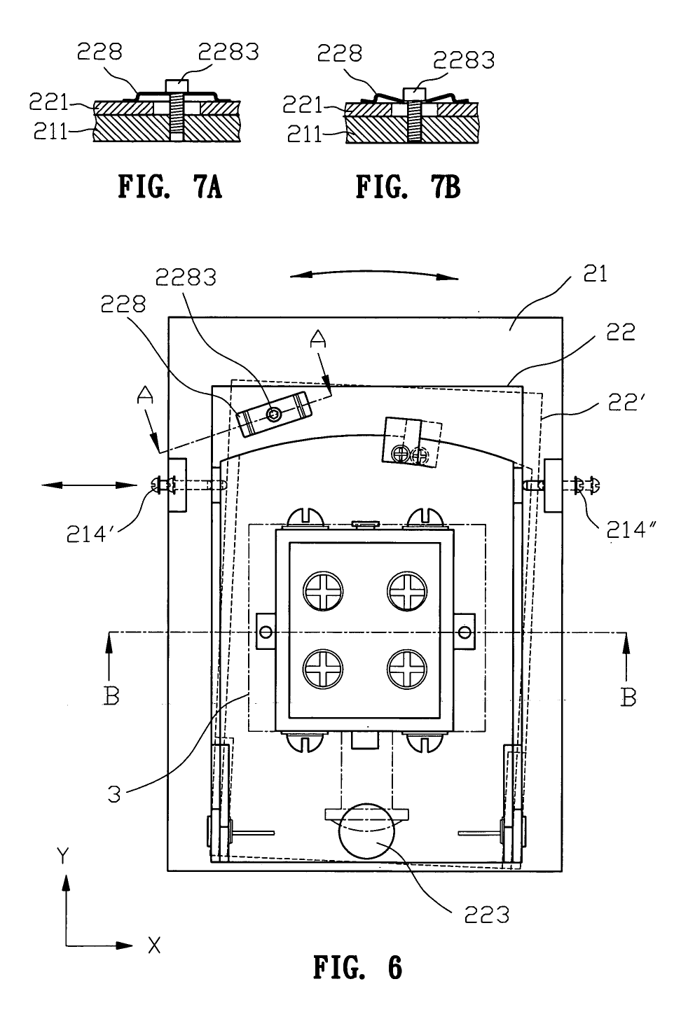

Please refer to FIG. 6. FIG. 6 is a top view showing an adjusting apparatus according to the present invention, and FIGS. 7A and 7B are cross sectional views along line A-A shown in FIG. 6. The figures show the working condition of the first rotating seat 22. After the guide element 2283 is loosened (as FIG. 7A shows), rotate the first adjusting element 214′ at one side to cause one end thereof to prop against the propping face 224 of the first rotating seat 22 to push the first rotating seat 22 to rotate around the pivoting hole 223 clockwise to a predetermined position (i.e. a first rotating seat 22′ shown with a dotted line in FIG. 6), and finally revolve the guide element 2283 tightly (as FIG. 7B shows) to complete the fixation of the first rotating seat 22. And vice versa, revolve a first adjustment element 214″ at another side to cause the first rotating seat 22 to be rotated counterclockwise so as to attain to the adjustment of the Z-axis rotating angle of the first rotating seat 22.

Please refer to FIG. 5. The second rotating seat 23 is mounted on the first rotating seat 22. The second rotating seat 23 comprises a rectangular second base plate 231, in which a second side plate 232 is disposed at each of the two sides of one end of the second base plate 231 corresponding to the first side plate 222. Pivoting holes 2321 matched up with the through holes 222 are disposed in the upper ends of the side plate 232, a pivoting rod 233 is passed through the through hole 2221 and the pivoting hole 2321 from the outside of the first side plate 222, and an elastic clamping washer 2331 is then used to limit the free end of the pivoting rod 233 so as to get the second rotating seat 23 to be pivotally connected to the first rotating seat 22. Furthermore, another end of the second base plate is placed in the gap 2262 of the reverse L shape plate 226, and the fixing element 227 is propped against the upper end face of the second base plate 231. A second adjusting element 234 is passed through the base seat 21 from the bottom thereof and passed through the first rotating seat 22 after being screwed in the rectangular base plate 211 to prop against the lower end face of the second base plate 231. The second rotating seat 233 is driven to rotate around the central axis (i.e. Y-axis) of the pivoting hole by revolving the second adjusting element 234.

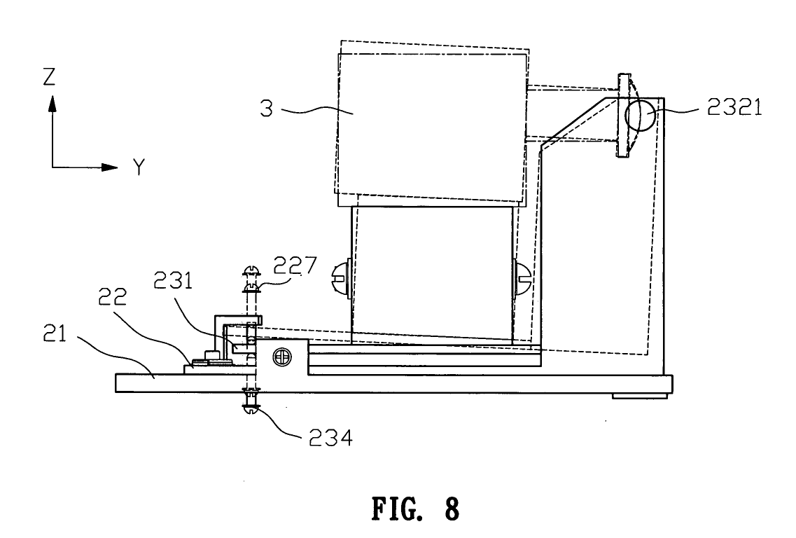

Please refer to FIG. 8. FIG. 8 is a side view showing an adjusting apparatus. The figure shows the action situation of the second rotating seat. Revolve the second adjusting element 234 below the second base plate 21 to move upward after the first rotating seat 22 and the base seat 21 are locked and connected by the guide element 234 to allow one end thereof to be propped against the lower end face of the second base plate 231 to push the second rotating seat 23 to be rotated around the pivoting hole 2321 clockwise. And vise versa, revolve the second adjusting element 234 to move it downward to cause the second rotating seat 23 to be rotated counterclockwise around the pivoting hole 2321 by its own gravity. The fixing element 227 is screwed to prop against the upper end face of the second base plate after the second the rotating seat 23 is rotated to a predetermined position so as to thrust the second base plate 231 to fix with the second adjusting element. Thereby, the adjustment of the Y-axis rotating angle rotating angle of the second rotating seat 23 can be attained.

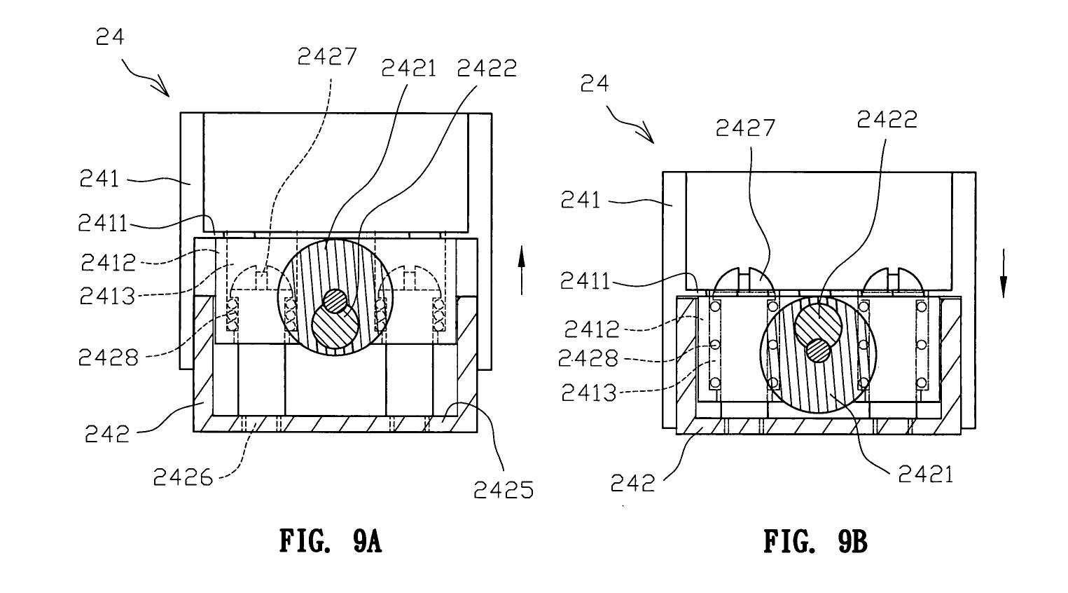

Please refer to FIGS. 5 and 9A. FIGS. 5 and 9A are cross sectional views along line B-B shown in FIG. 6. The elevating seat 24 is mounted and fixed on the second rotating seat 23. The elevating seat 24 comprises a movable seat 241 and fixing seat 242, in which the movable seat 241 is a hollow parallelepiped and a partition plate 2411 is installed levelly in the movable seat 241. A multiple of columns 2412 are projected downward from the partition plate 2411 and a stepwise hole 2413 with an area larger at the top and smaller at the bottom is passed through in each column 2412. A plurality of rectangular guide grooves are disposed in each of the opposite side faces of the movable 241, in which the longitudinal direction of the rectangular guide groove 2414 is parallel to the elevating direction of (i.e. Z direction) the movable seat 241. And, the fixing seat 242 is a “U” shape body and engaged below the movable seat 241. An adjusting shaft 2422 engaged with an eccentric wheel 2421 at the center thereof is pivotally disposed at the two opposite side faces and parallel to the X-axis, in which the top face of the eccentric wheel 2421 is propped against the lower surface of the partition plate 2411. A plurality of fixing holes 2423 matched up with the rectangular guide grooves 2414 is disposed in the side faces of the fixing seat 242 relative to the rectangular guide grooves 2414. Guide elements 2424 are passed through the rectangular guide grooves 2414 to allow one ends of them are engaged in the fixing holes and another ends of them are located on the rectangular guide grooves 2414 so as to guide the movable seat 242 to move along the Z-axis relatively to the fixing seat 242. A plurality of fixing holes 2426 relative to the positions and the numbers of the stepwise holes 2413 are disposed in the bottom face 2425 of the fixing seat 242. A fixing element 2427 is passed through each stepwise hole 2413 to the degree that one end thereof is locked and fixed in the fixing hole 2426 after being engaged with an elastic element 2428 and another end thereof is limited in the stepwise hole 2413 to cause the top face of the eccentric wheel 2421 to be propped against the lower surface of the partition plate 2411 tightly.

As to the action situation of the elevating seat 24, revolve the adjusting shaft 2422 to drive the eccentric wheel 2421 to rotate so as to cause the top of the eccentric wheel 2421 to push the lower surface of the partition plate 2411 and cause the movable seat 241 to move up and down relatively to the fixing seat 242 by operating in coordination with the distance change of the axle center of the eccentric wheel 2421 and the lower surface of the partition plate 2411 and utilizing the matching guidance of the guide elements 2424 and the rectangular guide grooves 2414. That the movable seat 241 is in an elevating state is shown in FIG. 9A and that the movable seat 241 is in a descending state is shown in FIG. 9B. Thereby, the adjustment of the Z-axis elevating height of the elevating seat 24 can be attained.

After the assembly of the multi-axis adjusting apparatus 20 according to the present invention is completed, the optical engine assembly can be mounted on the elevating seat 24 and the lens thereof is disposed facing to the X-axis. The angle (i.e. the leftward and the rightward inclined angle of the optical engine assembly 3) between the image of the optical engine assembly 3 and the screen plane is changed so as to attain to the adjustment of the leftward and rightward trapezoid deformations of the image when the first adjusting element 214 is revolved. The angle (i.e. the frontward and the rearward inclined angle of the optical engine assembly 3) between the image of the optical engine assembly 3 and the normal plane of the screen is changed so as to attain to the adjustment of the upward and downward trapezoid deformations of the image when the second adjusting element 214 is revolved. The image of the optical engine assembly is caused to move up and down relatively to the screen to adjust the upward or downward location thereof so as to align it with the screen. Therefore, the Z axial rotating angle, the Y axial rotating angle and the Z axial linear movement of the optical engine assembly can be quickly adjusted to attain to the adjustment of the trapezoid deformation and the screen alignment of the image from the optical engine assembly only by respectively revolving the first adjusting element 214, the second adjusting element 234 and the adjusting shaft 2422.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A multi-axis adjusting apparatus, comprising:
a base seat;
a first rotating seat, mounted on said base seat and having a first base plate, one end of said first base plate being pivotally connected to said base seat and a propping face being disposed at each of the two side of another end thereof, at least one adjusting element being installed at the flank side of each said propping face, one end of said adjusting element being screwed in said base seat and another end thereof being propped against said propping face; and
a second rotating seat, mounted on said first rotating seat and having a second base plate, one end of said second base plate being pivotally connected to said first rotating seat and an adjusting element being install at another end thereof, said adjusting element being screwed in said base seat and being passed through said first rotating seat to prop against below said second base plate.

2. The multi-axis adjusting apparatus according to claim 1, wherein pivoting rods of said first rotating seat and said second rotating seat are perpendicularly to each other.

3. The multi-axis adjusting apparatus according to claim 1, wherein an arc guide groove is disposed in said first rotating seat and a “ [symbol] ” shape elastic plate on said guide groove and a guide element is passed through said elastic plate.

4. The multi-axis adjusting apparatus according to claim 1, wherein corresponding first side plates and second side plates are respectively disposed at the two sides of said first base plate and said second base plate, a through hole matched to pivotally connect is disposed in the upper end of each said side plate.

5. The multi-axis adjusting apparatus according to claim 1, wherein a reverse “L” shape plate is disposed on said first base plate, a gap exists between the top face thereof and said first base plate, one end of said second base plat is located in said gap, a fixing element is passed through the top face of said reverse “L” shape plate to prop against the upper end face of said second base plate, a second adjusting element is passed through said base seat to prop against the lower end face of said second base plate after being screwed in said first base plate so as to adjust said second rotating seat to do Y-axis rotation.

6. The multi-axis adjusting apparatus according to claim 1, further comprising an elevating seat, said elevating seat being mounted on said second rotating seat, and comprising a movable seat and a fixing seat engaged below said movable seat, said movable seat, an adjusting shaft passing through an eccentric wheel being pivotally connected to said fixing seat, the top face of said eccentric wheel being propped against said movable seat.

7. The multi-axis adjusting apparatus according to claim 6, wherein a plurality of rectangular guide grooves are disposed in the side faces of said movable seat, fixing holes relative to said rectangular guide grooves are disposed in the side faces of said fixing seat, a guide is passed through one end of each said rectangular guide groove and screwed in said fixing hole to guide said movable seat to move along Z-axis.

8. The multi-axis adjusting apparatus according to claim 6, wherein a partition plate with stepwise holes therein is installed in said movable seat, fixing holes corresponding to said stepwise holes are disposed in said fixing seat, a fixing element engaged with an elastic element thereon is passed through each said stepwise hole and one end thereof is screwed in said fixing hole so as to cause the top face of said eccentric wheel to be propped against said partition plate tightly.

9. The multi-axis adjusting apparatus according to claim 6, wherein an optical engine is mounted on said elevating seat.
